(19) United States
(12) Patent Application Publication
(10) Pub. No.: US 2026/0185862 A1
(43) Pub. Date: Jul. 2, 2026

(54) GAS CYLINDER CONNECTOR WITH ELECTRONIC DETECTION METER

(71) Applicant: NINGBO WANAN CO., LTD, Ningbo (CN)

(72) Inventors: Feng ZHANG, Ningbo (CN); Yu ZHANG, Ningbo (CN); Jinghui FAN, Ningbo (CN)

(73) Assignee: NINGBO WANAN CO., LTD, Ningbo (CN)

(21) Appl. No.: 19/004,840

(22) Filed: Dec. 30, 2024

(51) Int. Cl. G01F 22/02; F17C 13/04

(52) U.S. Cl. CPC G01F 22/02; F17C 13/04; F17C 2205/0146; F17C 2250/034; F17C 2250/043; F17C 2250/0447; F17C 2250/0486

(57) ABSTRACT

A gas cylinder connector with an electronic detection meter includes a connection head, a connection tube, a gas quantity detection device, and a gas quantity display device. An end of the connection tube is detachably connected to the connection head, and the gas quantity detection device and the gas quantity display device are electrically connected. The gas quantity display device is detachably connected to the gas quantity detection device. A blocking component is connected to the connection tube, and the connection head can drive the blocking component to automatically open, thereby connecting the connection head with the connection tube. A positioning locking component is connected to the connection tube, and the connection tube locks the position of the connection head through the positioning locking component, achieving a limited position sealing connection between the connection tube and the connection head.

### TECHNICAL FIELD

This present disclosure pertains to the field of electronic gas meter technology, specifically referring to a gas cylinder connector equipped with an electronic detection meter.

### BACKGROUND

Electronic gas meters are devices used to measure and record the usage of gases such as natural gas and liquefied petroleum gas. Currently, gas cylinders often have shut-off valve directly connected to the gas pipeline without a gas volume display function. Some may have a pressure gauge installed on the shut-off valve, but since the shut-off valve is typically placed in a concealed location directly under the cooking stove along with the gas cylinder, it is not convenient to check. Moreover, existing connection hoses are mostly threaded connections with gas pipe, requiring the placement of a sealing ring at the connection point, followed by tightening bot, ends with a wrench, which is a cumbersome operation. Additionally, the connection hose does not have the function of automatically closing when not connected and automatically opening when connected. If the connection hose and gas pipe are accidentally disconnected while the valve is open, it could lead to the safety risk of gas leakage.

### SUMMARY

The present disclosure aims to address the technical issue that the connection tube, equipped only with a shut-off valve, lacks a gas volume display function; even if a pressure gauge is installed, it is not conveniently accessible for checking; the connection tube and gas pipe are connected using threaded connections, which is a cumbersome operation; moreover, the connection tube does not have the function of automatically closing when disconnected and automatically opening when connected, which can lead to the safety risk of gas leakage.

A gas cylinder connector with electronic detection meter includes a connection head for connecting to a gas pipe, a connection tube, a gas quantity detection device, and a gas quantity display device, the connection tube is threaded at one end to connect with the gas cylinder and an end of the connection tube is detachably connected to the connection head, the gas quantity detection device is connected to the connection tube, and the gas quantity detection device is electrically connected to the gas quantity display device; the gas quantity display device is detachably connected to the gas quantity detection device, and the gas quantity display device is wirelessly connected to the gas quantity detection device; a blocking component is connected to the connection tube, and the connection head drive the blocking component to automatically open, thereby connecting the connection head to the connection tube; a positioning locking component is connected to the connection tube, and the connection tube locks the position of the connection head through the positioning locking component, achieving a limited position sealing connection between the connection tube and the connection head.

Further, the gas quantity display device including a display casing, and the bottom end of the display casing is circumferentially connected to a plurality of positioning clips, the positioning clips are of an L-shaped structure, and the top end of the gas quantity detection device is circumferentially connected with positioning grooves, the positioning grooves cooperate with the positioning clips for positioning. It is convenient for the display casing to be detachably connected with the gas quantity detection device, so that the gas quantity display device can be directly mounted on the gas quantity detection device, and at the same time, it is also convenient to be detached and mounted in other places where it is convenient to observe the gas quantity.

Further, the positioning groove including an entry groove and a latch groove, the width of the entry groove is not less than the width of the positioning clip, one end of the entry groove is pierced through the gas quantity detection device, and the other end is connected to the latch groove. First, extend the positioning clip along the direction of the opening in the entry groove direction and slide it downward until it is flush with the lower surface of the latch groove, and then rotate the display casing along the direction close to the latch groove to make the positioning clip cooperate with the latch groove, then the installation is completed.

Further, the blocking component including a first annular groove connected inside the connection tube, a first sliding ring slidingly connected inside the first annular groove, a first spring connected between the first sliding ring and the first annular groove, an inner cylinder connected to the first sliding ring, a plurality of through holes evenly arranged around the inner cylinder, the inner cylinder has one end away from the center of the connection tube butted against the connection head, and the other end of the inner cylinder is connected to a blocking head, the blocking head is connected to a first sealing ring, and the blocking head is sealed in cooperation with the connection tube via the first sealing ring. Under the drive of the first spring, the first sliding ring drives the inner cylinder to slide away from the center of the connection tube until the blocking head is sealed in conjunction with the first sealing ring and the connection tube; when the connection head drives the inner cylinder to slide towards the center of the connection tube, causing the through hole to extend out of the position of the hollow frustum, thereby allowing the gas on one side of the connection tube to be introduced into the gas pipe on the side of the connection head through the through hole.

Further, the blocking head is a frustum structure, and the connection tube is connected internally with a hollow frustum, the taper of the hollow frustum being coordinated with the taper of the blocking head.

Further, the positioning locking component including a driving sleeve slidingly connected to the outside of the connection tube, a second spring connected between the driving sleeve and the connection tube, a receiving annular groove connected to the inner wall of the driving sleeve, a plurality of perforating holes evenly arranged around the connection tube, a positioning bead movably disposed within the perforating hole, a second annular groove connected to the connection head, and the second annular groove cooperating with the positioning bead; a positioning seat is connected to the inner wall of the connection tube, a second sealing ring is connected to the connection tube on the side close to the connection head at the positioning seat, and the free end of the connection head is sealed in cooperation with the positioning seat via the second sealing ring, first slide the driving sleeve towards the gas quantity detection device, making the positioning bead relative to the receiving annular groove, at this time the second spring is compressed and stored, then insert the connection head into the connection tube, the connection head drives the positioning bead to move towards the receiving annular groove, until the second annular groove is opposite to the positioning bead, release the driving sleeve, and under the action of the second spring returning to its original position, the driving sleeve drives the positioning bead to move towards the second annular groove and limits the positioning bead between the driving sleeve and the second annular groove, thereby facilitating the positioning and clamping of the connection head. At this time, the free end of the connection head is sealed with the connection tube through the second sealing ring.

Further, the connection head has a protruding ring connected on one side of the second annular groove, the protruding ring is coaxially arranged with the inner cylinder, the side of the protruding ring close to the connection tube is chamfered, and the end of the inner cylinder close to the connection head cooperates with the chamfered side of the protruding ring. To facilitate the coaxially arranged of the connection head and the connection tube, which makes it easier to drive the inner cylinder.

Further, the gas quantity detection device including a measurement shell, a measurement battery, a sensor capable of measuring gas pressure, a first microprocessor, and a wireless signal transmission module, the measurement battery supplies energy to the sensor, the first microprocessor, and the wireless signal transmission module, and the first microprocessor is electrically connected to the sensor and the wireless signal transmission module.

Further, the gas quantity display device further including a second microprocessor, a display screen, a display battery, and a wireless signal reception module, the display battery supplies energy to the second microprocessor, the display screen, and the wireless signal reception module, and the second microprocessor is electrically connected to the display screen and the wireless signal reception module, and the wireless signal reception module is signal-connected to the wireless signal transmission module.

Further, the wireless signal transmission module and the wireless signal reception module both employ a Bluetooth module or a Wi-Fi module.

The advantages of the present disclosure are as follows.

The detachable arrangement of the gas quantity display device and the gas quantity detection device facilitates their separation, allowing the gas quantity display device to be conveniently installed at suitable locations as needed.

The configuration of the blocking component allows the connection tube to be sealed when not connected to the connection head, preventing gas from leaking out of the gas cylinder through the connection tube. Additionally, when the connection head is inserted into the connection tube, it can drive the blocking component to automatically open.

The positioning locking component allows for quick locking and positioning of the connection head as it extends into the connection tube, facilitating a sealed connection between the connection tube and the connection head.

### BRIEF DESCRIPTION OF THE DRAWINGS

FIG. 1 is a schematic structural diagram of a gas cylinder connector with electronic detection meter according to this disclosure.

FIG. 2 is a second schematic structural diagram of a gas cylinder connector with electronic detection meter according to this disclosure.

FIG. 3 is a third schematic structural diagram of a gas cylinder connector with electronic detection meter according to this disclosure.

FIG. 4 is an enlarged structural diagram of part C in FIG. 3.

FIG. 5 is a top view structural diagram of a gas cylinder connector with electronic detection meter according to this disclosure.

FIG. 6 is a sectional view structural diagram of part A-A in the gas cylinder connector with electronic detection meter according to this disclosure.

FIG. 7 is a sectional view structural diagram of part B-B in the gas cylinder connector with electronic detection meter according to this disclosure.

FIG. 8 is an enlarged structural diagram of part E in FIG. 7.

### DETAILED DESCRIPTION OF THE EMBODIMENTS

The technical solution of the present disclosure will be described clearly and completely in conjunction with the drawings of the embodiment of the present disclosure. It is evident that the described embodiment is only a part of the embodiments of the present disclosure, not all of them. Based on the embodiment of the present disclosure, all other embodiments obtained by those skilled in the art without making creative efforts are within the scope of protection of the present disclosure.

### Embodiment One

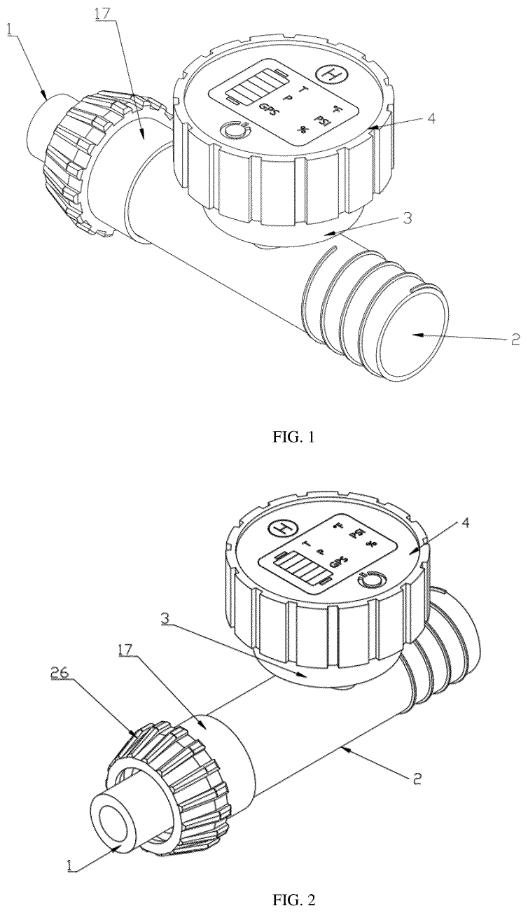

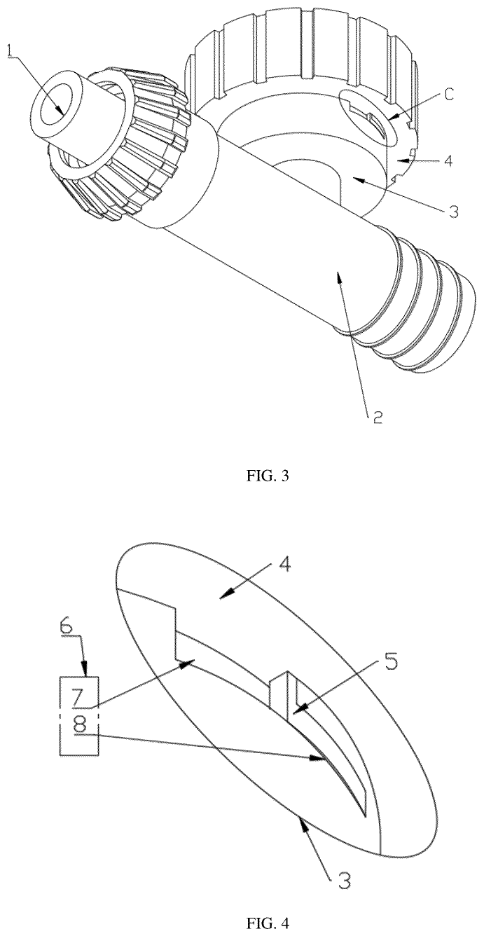

Referring to FIGS. 1, 2, 3, and 4, a gas cylinder connector with electronic detection meter includes a connection head 1 for connecting a gas pipe, a connection tube 2, a gas quantity detection device 3, and a gas quantity display device 4. The connection tube 2 is threaded at one end to connect with the gas cylinder, and the other end is detachably connected with the connection head 1. The gas quantity detection device 3 is mounted on the connection tube 2, and the gas quantity display device 4 is wirelessly connected to the gas quantity detection device 3. The gas quantity display device 4 is detachably connected to the gas quantity detection device 3. The gas quantity display device 4 includes a display casing, and the bottom end of the display casing is circumferentially connected to a plurality of positioning clips 5. The positioning clips 5 are of an L-shaped structure. The top end of the gas quantity detection device 3 is circumferentially connected to a positioning groove 6, which cooperates with the positioning clip 5 for positioning. The positioning groove 6 includes an entry groove 7 and a latch groove 8. The width of the entry groove 7 is not less than the width of the positioning clip 5. One end of the entry groove 7 penetrates the gas quantity detection device 3, and the other end is connected to the latch groove 8.

Through the above structure, the positioning groove 6 and the positioning clip 5 cooperate for positioning, which facilitates the detachable connection of the display casing with the gas quantity detection device 3, thereby achieving a detachable setting of the gas quantity display device 4 and the gas quantity detection device 3. It is convenient to directly install the gas quantity display device 4 on the gas quantity detection device 3 and also facilitates the disassembly and installation in other places that are convenient for observing the gas quantity.

### Embodiment Two

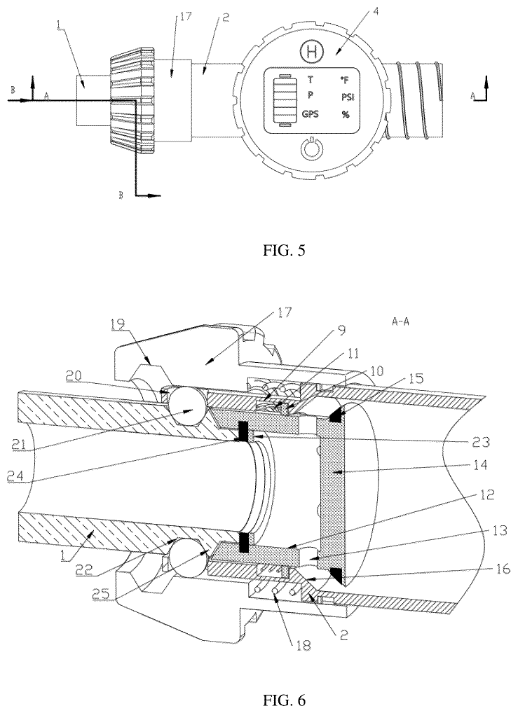

Building on embodiment one and referring to FIGS. 5 and 6, a blocking component is connected to the connection tube 2. The connection head 1 can drive the blocking component to automatically open, thereby connecting the connection head 1 with the connection tube 2. The blocking component includes a first annular groove 9 connected to the inside of the connection tube 2, a first sliding ring 10 connected to slide within the first annular groove 9, a first spring 11 connected between the first sliding ring 10 and the first annular groove 9, an inner cylinder 12 connected to the first sliding ring 10, a plurality of through holes 13 evenly arranged around the inner cylinder 12, the inner cylinder 12 extending away from the center of the connection tube 2 and connected to the connection head 1 at one end, and a blocking head 14 connected to the other end of the inner cylinder 12. The blocking head 14 is connected to a first sealing ring 15 and is sealed in cooperation with the connection tube 2 via the first sealing ring 15. The blocking head 14 is a frustum structure, and the connection tube 2 is connected to a hollow frustum 16 inside, the taper of which is coordinated with the taper of the blocking head 14.

The setting of the blocking component in the above structure facilitates the blocking of the connection tube 2 when not connected to the connection head 1, preventing the gas from the gas cylinder from leaking out through the connection tube 2. At the same time, when the connection head 1 is inserted into the connection tube 2, it can drive the blocking component to automatically open, facilitating the connection between the gas pipe and the gas cylinder.

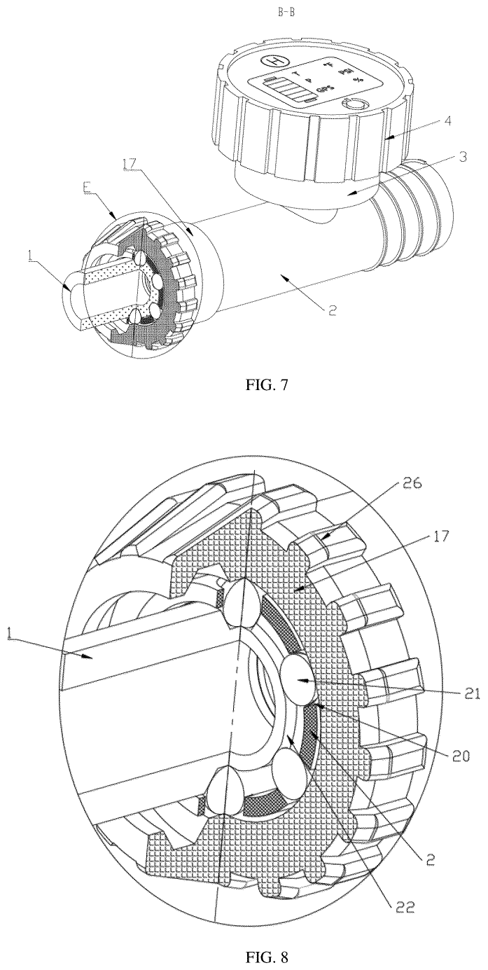

Referring to FIGS. 6, 7, and 8, a positioning locking component is connected to the connection tube 2. The connection tube 2 locks the position of the connection head 1 through the positioning locking component and makes the connection tube 2 and the connection head 1 positionally sealed. The positioning locking component includes a driving sleeve 17 slidingly connected to the outside of the connection tube 2, a plurality of anti-slip protrusions 26 evenly connected around the driving sleeve 17, a second spring 18 connected between the driving sleeve 17 and the connection tube 2, a receiving annular groove 19 connected to the inner wall of the driving sleeve 17, a plurality of perforating holes 20 evenly arranged around the connection tube 2, a positioning bead 21 movably set within the perforating hole 20, a second annular groove 22 connected to the connection head 1 and cooperating with the positioning bead 21, a positioning seat 23 connected to the inner wall of the connection tube 2, a second sealing ring 24 connected to the connection tube 2 near the positioning seat 23 and sealingly cooperating with the connection head 1 at the free end, and a convex ring 25 connected to the connection head 1 on the side of the second annular groove 22. The convex ring 25 is coaxially set with the inner cylinder 12, with a chamfered edge on the side close to the connection tube 2, and the inner cylinder 12 at the end close to the connection head 1 is coordinated with the chamfered side of the convex ring 25.

The setting of the positioning locking component in the above structure facilitates the locking and positioning of the position where the connection head 1 is inserted into the connection tube 2, and conveniently makes the connection tube 2 and the connection head 1 sealingly cooperate.

### Embodiment Three

Based on embodiment one and referring to FIGS. 1, 2, and 5, the gas quantity detection device 3 includes a measurement shell, a measurement battery, a sensor capable of measuring gas pressure, a first microprocessor, and a wireless signal transmission module. The measurement battery supplies energy to the sensor, the first microprocessor, and the wireless signal transmission module. The first microprocessor is electrically connected to the sensor and the signal transmission circuit. In a specific implementation, the gas quantity detection device 3 also has a temperature sensor capable of detecting ambient temperature.

Referring to FIGS. 1, 2, and 5, the gas quantity display device 4 also includes a second microprocessor, a display screen, a display battery, and a wireless signal reception module. The display battery supplies energy to the second microprocessor, the display screen, and the wireless signal reception module. The second microprocessor is electrically connected to the display screen and the wireless signal reception module. The wireless signal reception module is signal-connected to the wireless signal transmission module, and both the wireless signal transmission module and the wireless signal reception module use bluetooth module or wifi module.

Through the sensor setting in the above structure, it is convenient to detect the pressure inside the gas cylinder, and then transmit the data to the first microprocessor for analysis, thereby calculating the gas quantity inside the cylinder and transmitting the results to the wireless signal reception module via the wireless signal transmission module. The second microprocessor receives the signal from the wireless signal reception module and converts it for display on the screen. The wireless signal transmission module and the wireless signal reception module can be composed of bluetooth module or wifi module.

The display screen can display items including: remaining gas quantity display, remaining gas quantity percentage display, ambient temperature display, battery power display, and gas pressure display.

The remaining gas quantity display is as follows:
81% to 100% full capacity display;
61% to 80% ⅘ capacity display;
41% to 60% ⅗ capacity display;
21% to 40% ⅖ capacity display;
6% to 20% ⅕ capacity display, with a slow flashing graphic;
0% to 5% no capacity display, with a flashing graphic.

The remaining gas quantity percentage display:

Based on ambient temperature and gas pressure data, the remaining gas quantity is displayed in percentage form.

Ambient temperature display:

Displays the current ambient temperature in Fahrenheit.

Battery power display:
81% to 100% full capacity display;
61% to 80% ⅘ capacity display;
41% to 60% ⅗ capacity display;
21% to 40% ⅖ capacity display;
0% to 20% ⅕ capacity display;
0% to 5% no capacity display, with a flashing graphic.

Gas pressure display:

Displays the current gas cylinder pressure in PSI units.

The specific method of use is as follows:

First, slide the positioning clip 5 into the entry groove 7 in the direction of the opening and down until it is flush with the lower surface of the latch groove 8; then rotate the display casing towards the latch groove 8 direction until the positioning clip 5 cooperates with the latch groove 8, completing the installation of the gas quantity display device 4 with the gas quantity detection device 3. Conversely, if disassembly is needed, rotate the display casing counterclockwise to withdraw the positioning clip 5 from the latch groove 8 until the positioning clip 5 is completely inside the entry groove 7, then pull the positioning clip 5 out of the entry groove 7.

In the blocking state, the first spring 11 is in a stretched state, and the first sliding ring 10, under the action of the first spring 11, causes the inner cylinder 12 to drive the blocking head 14 to tightly adhere to the connection tube 2, and the first sealing ring 15 is set to improve the sealing performance between the blocking head 14 and the connection tube 2.

When connecting the connection head 1 and the connection tube 2 is required, first slide the driving sleeve 17 towards the gas quantity detection device 3, making the positioning bead 21 relative to the receiving annular groove 19, at this time the second spring 18 is compressed and stored, and the anti-slip protrusions 26 are set to increase the friction of the driving sleeve 17, thereby facilitating the effective driving of the driving sleeve 17. Then insert the connection head 1 into the connection tube 2, the connection head 1 drives the positioning bead 21 to move towards the receiving annular groove 19, until the second annular groove 22 is opposite to the positioning bead 21, release the driving sleeve 17, and under the action of the second spring 18 returning to its original position, the driving sleeve 17 drives the positioning bead 21 to move towards the second annular groove 22 and limits the positioning bead 21 between the driving sleeve 17 and the second annular groove 22, thereby facilitating the positioning and clamping of the connection head 1. At this time, the free end of the connection head 1 is sealed with the connection tube 2 through the second sealing ring 24.

During the process where the connection head 1 drives the inner cylinder 12 to slide towards the center of the connection tube 2 through the convex ring 25, the through hole 13 extend out of the position of the hollow frustum 16, thereby allowing the gas on one side of the connection tube 2 to be introduced into the gas pipe on the side of the connection head 1 through the through hole 13. The chamfered setting facilitates the coaxial alignment of the connection head 1 with the inner cylinder 12, facilitating the driving of the inner cylinder 12, and also facilitating the connection head 1 to be at the center of the connection tube 2, facilitating the stable sealing effect of the second sealing ring 24.

It should be noted that in this text, relational terms such as “first” and “second” are used solely to distinguish one entity or operation from another, without necessarily implying or suggesting any actual relationship or order between these entities or operations. Moreover, the term “include,” “comprising,” or any other variant is intended to encompass non-exclusive inclusion, so that a process, method, item, or device that includes a list of elements is not limited to those elements but may also include other elements that are not expressly listed, or inherent in such a process, method, item, or device.

Although examples of the present disclosure have been shown and described, it will be understood by those skilled in the art that various changes, modifications, substitutions, and variations can be made to these examples without departing from the principles and spirit of the present disclosure, and the scope of the present disclosure is defined by the appended claims and their equivalents.

The description provided above of the disclosure and its embodiments is not limiting; the figures shown are merely one example of the implementation of the disclosure, and the actual structure is not limited thereto. In summary, if those skilled in the art, inspired by it, create similar structural methods and embodiments without departing from the creative purpose of the disclosure, they should all fall within the protective scope of the present disclosure.

What is claimed is:

1. A gas cylinder connector with an electronic detection meter, comprising a connection head for connecting to a gas pipe, a connection tube, a gas quantity detection device, and a gas quantity display device, wherein
an end of the connection tube is detachably connected to the connection head, the gas quantity detection device is connected to the connection tube, and the gas quantity detection device is electrically connected to the gas quantity display device; the gas quantity display device is detachably connected to the gas quantity detection device, and the gas quantity display device is wirelessly connected to the gas quantity detection device;
a blocking component is connected to the connection tube, and the connection head drive the blocking component to automatically open, thereby connecting the connection head to the connection tube; and
a positioning locking component is connected to the connection tube, and the connection tube locks a position of the connection head through the positioning locking component, achieving a limited position sealing connection between the connection tube and the connection head.

2. The gas cylinder connector according to claim 1, wherein the gas quantity display device comprises a display casing, and a bottom end of the display casing is circumferentially connected to a plurality of positioning clips, the positioning clips are of an L-shaped structure, and a top end of the gas quantity detection device is circumferentially connected with positioning grooves, the positioning grooves cooperate with the positioning clips for positioning.

3. The gas cylinder connector according to claim 2, wherein the positioning groove comprises an entry groove and a latch groove, a width of the entry groove is not less than a width of the positioning clip, one end of the entry groove is pierced through the gas quantity detection device, and another end of the entry groove is connected to the latch groove.

4. The gas cylinder connector according to claim 1, wherein the blocking component comprises a first annular groove connected inside the connection tube, a first sliding ring slidingly connected inside the first annular groove, a first spring connected between the first sliding ring and the first annular groove, an inner cylinder connected to the first sliding ring, a plurality of through holes evenly arranged around the inner cylinder, the inner cylinder has one end away from a center of the connection tube butted against the connection head, and another end of the inner cylinder is connected to a blocking head, the blocking head is connected to a first sealing ring, and the blocking head is sealed in cooperation with the connection tube via the first sealing ring.

5. The gas cylinder connector according to claim 4, wherein the blocking head is a frustum structure, and the connection tube is connected internally with a hollow frustum, a taper of the hollow frustum is coordinated with a taper of the blocking head.

6. The gas cylinder connector according to claim 4, wherein the positioning locking component comprises a driving sleeve slidingly connected to an outside of the connection tube, a second spring connected between the driving sleeve and the connection tube, a receiving annular groove connected to an inner wall of the driving sleeve, a plurality of perforating holes evenly arranged around the connection tube, a positioning bead movably disposed within the perforating hole, a second annular groove connected to the connection head, and the second annular groove cooperating with the positioning bead; a positioning seat is connected to the inner wall of the connection tube, a second sealing ring is connected to the connection tube on a side close to the connection head at the positioning seat, and a free end of the connection head is sealed in cooperation with the positioning seat via the second sealing ring.

7. The gas cylinder connector according to claim 6, wherein the connection head has a protruding ring connected on one side of the second annular groove, the protruding ring is coaxially arranged with the inner cylinder, a side of the protruding ring close to the connection tube is chamfered, and an end of the inner cylinder close to the connection head cooperates with a chamfered side of the protruding ring.

8. The gas cylinder connector according to claim 1, wherein the gas quantity detection device comprises a measurement shell, a measurement battery, a sensor capable of measuring gas pressure, a first microprocessor, and a wireless signal transmission module, the measurement battery supplies energy to the sensor, the first microprocessor, and the wireless signal transmission module, and the first microprocessor is electrically connected to the sensor and the wireless signal transmission module.

9. The gas cylinder connector according to claim 8, wherein the gas quantity display device further comprises a second microprocessor, a display screen, a display battery, and a wireless signal reception module, the display battery supplies energy to the second microprocessor, the display screen, and the wireless signal reception module, and the second microprocessor is electrically connected to the display screen and the wireless signal reception module, and the wireless signal reception module is signal-connected to the wireless signal transmission module.

10. The gas cylinder connector according to claim 9, wherein the wireless signal transmission module and the wireless signal reception module both employ a Bluetooth module or a Wi-Fi module.
